(19) United States
(12) Patent Application Publication
(10) Pub. No.: US 2008/0314100 A1
(43) Pub. Date: Dec. 25, 2008

(54) Electric Anti-Impact Lock with Spring Accumulator

(76) Inventor: Hao Min, Nanjing (CN)

Correspondence Address: GLOBAL IP SERVICES, 7285 W. Eagle Court, Winton, CA, 95388, US

(21) Appl. No.: 12/200,726

(22) Filed: Aug. 28, 2008

Related U.S. Application Data
(63) Continuation-in-part of application No. 11/624,192, filed on Jan. 17, 2007.

(30) Foreign Application Priority Data
Sep. 25, 2006 (CN) 200620077575.4

(51) Int. Cl. E05B 49/00

(52) U.S. Cl. 70/278.1; 70/278.7

(57) ABSTRACT

An electric anti-impact lock with spring accumulator comprises a lock shell; a pivot keeper for locking door with a latch portion and a tail portion, the door can be opened when the latch portion pivoting into the shell, the door being locked when the latch portion pivoting outside the shell; a device for locking keeper comprising a slideable block bar, the keeper is locked when the slideable block bar being against the tail portion, the keeper is turnable when the slideable block being moved away; a anti-impact device having a reinforce structure, which bears a impact from the door through the keeper and the block bar; and a device for locking block bar is a block pin device with spring accumulator, the block pin shoots out to stop moving of the block bar when power on, thereby, the door being locked, the block pin withdrawing to free the stop when power on in reverse pole, the door can be opened. The new lock solves the problems of weakness and lock death for current electromagnetic locks in market. The cost of the new lock is lower and the manufacture is easy.

### CROSS REFERENCE TO THE RELATED PATENT APPLICATION

This patent application is a continuation in part application of the pending U.S. application Ser. No. 11/624,192 with a filing date Jan. 17, 2007, which claims the priority of the Chinese patent application No. 200620077575.4 with a filing date of Sep. 25, 2006.

### FIELD OF THE INVENTION

This invention relates to a new style of an electrical lock, especially relates a new style of the electrical lock having strong anti-impact ability.

### BACKGROUND OF THE INVENTION

Currently, most of the safety boxes, which use electromagnetic locks with fingerprint identification for safety purpose are used by banks, jewelry business, or firearms business etc. Unauthorized users cannot open the safety boxes, which are locked by the electromagnetic locks with fingerprint identification. However, the ability for anti-impact is a main concern in selecting electromagnetic locks. Sometimes, locks are required to suffer a strong impact over one ton without any damage for safety purpose.

Most electromagnetic locks in current market use electromagnet to open or close the lock. For example, when electromagnet is on power or off power, a lock pin is plugged into or pulled out from a slipping block, which controls a keeper to open or lock a door, but the lock pin is weak in structure.

Under this kind of design, the electromagnetic lock can be opened without any password, key and fingerprint if the lock pin, a weak part of the electromagnetic lock, is destroyed.

It is difficult to enforce the structure of the lock pin as the electromagnet force is relatively weak and the keeper is relatively heavy. Therefore, the lock pin is easy to be broken under an impact. This is a main hidden trouble of the safety box locked by common electromagnetic lock.

Also, the common electromagnetic locks have other problems. The electromagnet locks always become dead. It means that although tests of password, fingerprint and key are passed, the lock still cannot be opened. This is caused by shortages of the structure of the common electromagnet lock. When opening a safety box after tests of password, key and fingerprint, and if pulling the door little early, it means that one pulls the door before the keeper withdrawing, the force of friction for withdrawing the keeper is big as having a pull force on the keeper. At that time the force of the electromagnet is smaller than the force of friction. As a result, the keeper cannot be withdrawn. In order to reduce the force of friction, an operator can release the door for reducing the force of friction. However, the electromagnet becomes power off at the time of releasing the door, the keeper still cannot be withdrawn. Thus, all opening programs need to be repeated again from the beginning, such as putting password, comparing fingerprints, inserting keys and so on. It is disturbing.

### SUMMARY OF THE INVENTION

The purposes of the present invention are to solve the problems of the weakness and death of current electromagnetic locks, and is to design a stronger electric lock, which can survive under very strong impact, and will never become dead.

The creative concepts are that:

An electric anti-impact lock with spring accumulator is constituted by the following devices:

A lock shell. A pivot keeper for locking door with a latch portion and a tail portion, the door can be open when the latch portion pivots into the shell, and the door is locked when the latch portion pivots outside the shell. A device for locking keeper includes a slideable block bar, the keeper is locked when the slideable block bar is against the tail portion of the keeper, and the keeper becomes turnable after the block bar is moved away. An anti-impact device includes a reinforce structure for bearing an impact form door through the keeper and block bar. A device for locking block bar includes a block pin device with spring accumulater, a block pin protrudes out to stop moving of the block bar when power off/on, thereby the door is locked, the block pin withdraws inside to free the stop when power on/off, thereby, the door can be opened.

Moreover, the present invention has the following improvements:

the anti-impact device includes a reinforce structure being constructed as triangle reinforced rib having a inclined head, which is opposite to the inclined plane of the block bar, the impact on the door is transferred to the triangle reinforced rib through the inclined plane and inclined head.

The block pin device with spring accumulater includes an electric motor, a spring accumulator driven by the motor and a block pin driven by the accumulater. The block pin shoots out to the space after the block bar to lock the block bar when door is closed, the block pin withdraw to free the block bar when the door is opened. The turn of motor is not synchronized with the shooting or withdrawing of the block pin as having the accumulator.

The merits for the present invention:

1. This invention solves the problem of weakness existing in the current electromagnetic locks in current market, the new electric anti-impact lock with spring accumulator can guarantee no any break or distortion under 1000 kg impact. The safety grade is increased greatly.

2. This invention uses block pin device with spring accumulator to replace the electromagnet and implemental parts, thereby the death problem of the locks is solved. When the door of safety box cannot be opened as the force of friction between keeper and safety box, only need to push the door, then the door can be opened by pulling, the trouble of repeating the whole program again is gone.

3. This invention simplifies the lock structure, makes easy for the manufacture, and reduces the costs for products.

### BRIEF DESCRIPTION OF THE DRAWINGS

FIG. 1 is a sketch figure, which shows the structure of the electric anti-impact lock with spring accumulator of the present invention under lock condition.

FIG. 2 is a sketch figure, which shows the structure of the electric anti-impact lock of the present invention under unlock condition.

FIG. 3 is a sketch figure, which shows the structure of the electric anti-impact lock of the present invention under impact.

FIG. 4 is a sketch figure, which shows the configuration of the block bar.

FIGS. 5a to 5d are sketch figures, which show the configuration of the block pin device with spring accumulater and working principle.

FIG. 6 is a sketch figure, which shows the structure of the electric anti-impact lock with spring accumulator of another preferred embodiment of present invention.

FIG. 7 is a sketch figure, which shows the electrical controlling principle for the electric anti-impact lock with spring accumulator of the present invention

### DETAIL DESCRIPTION OF THE INVENTION

The accompanying drawings facilitate understanding of the preferred embodiments of this invention.

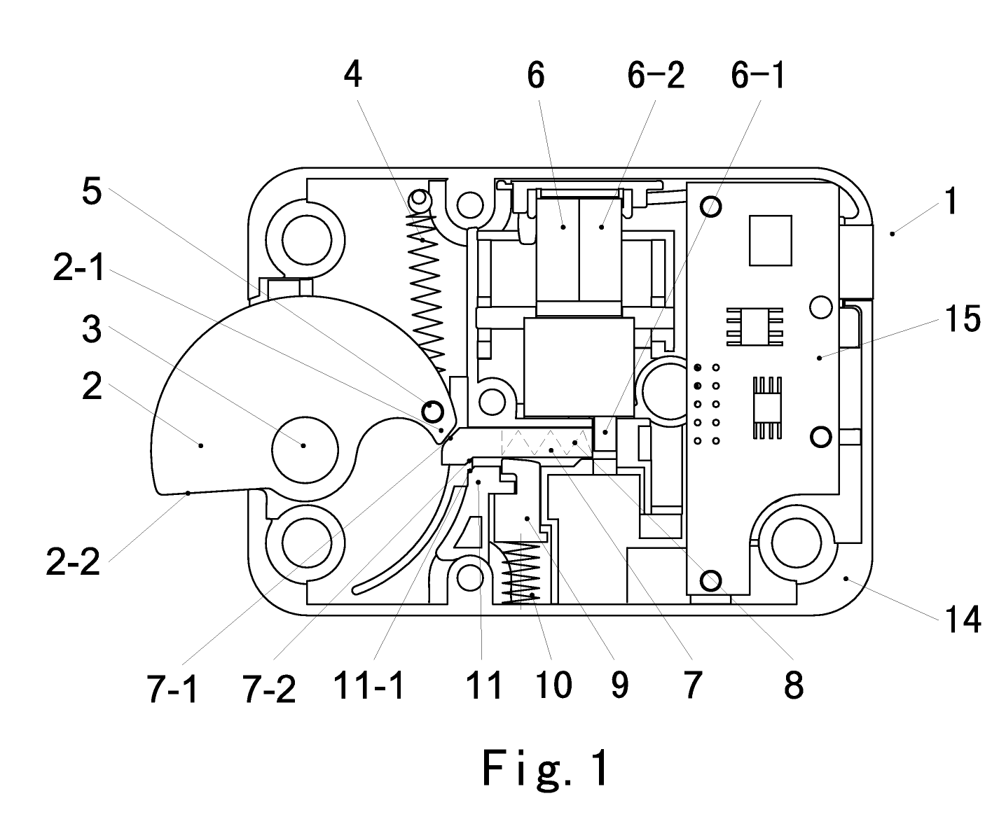

Refer to FIG. 1; it shows an electric anti-impact lock 1 with spring accumulator, which includes a lock shell 14, a keeper 2 for locking door, a device for locking keeper 2, an anti-impact device and a device for locking block bar.

The keeper 2 is pivoted on a keeper pivot 3 in the shell 14, has a cam shape with a latch portion 2-2 at one end and a tail portion 2-1 at other end. The latch portion 2-2 has a beeline outline and the tail portion 2-1 has a bevel face. One end of a first spring 4 is connected with the tail portion 2-1 and other end is connected with the shell 14. The first spring 4 is an extension spring, whose force pulls the keeper 2 to turn out of the shell 14.

The device for locking keeper includes a groove 12, a block bar 7 is slideable in the groove 12, a second spring 8 is a compress spring, one end of the second spring 8 is against the block bar 7, and other end is against the shell 14. The block bar 7 is against the tail portion 2-1 of the keeper 2 by the force of the second spring 8.

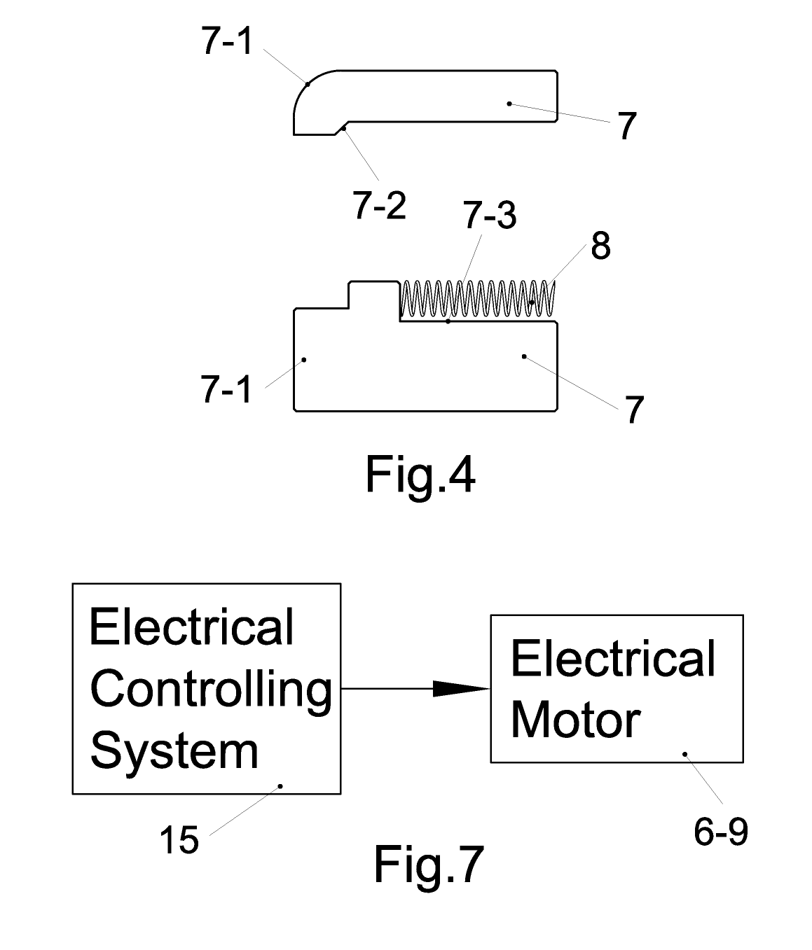

Refer to FIG. 4; the block bar 7 is a flat piece, has an arc shape head 7-1 and an inclined plane 7-2 opposite to the arc shape head 7-1, an flute 7-3 is on a side of the block bar 7, in which the second spring 8 is located. The groove 12 is wider than the block bar 7, thereby a clearance is existed between the groove 12 and the block bar 7. Therefore, the block bar 7 can slide into the groove 12, can also move up and down little in the groove 12.

Return to FIG. 1; the support column 9 is against a side of the block bar 7, a forth spring 10 is against the support column 9. The forth spring 10 is a compress spring. Under the force of forth spring 10, the block bar 7 is against the upside of the groove 12, the clearance is existed in the low side of the groove 12.

The anti-impact device includes a reinforced triangle rib 11 having an inclined head 11-1 opposite to and near the inclined plane 7-2 of the block bar 7. The reinforced triangle rib 11 is designed to suffer 1000 kg impact without becoming broken or distorted.

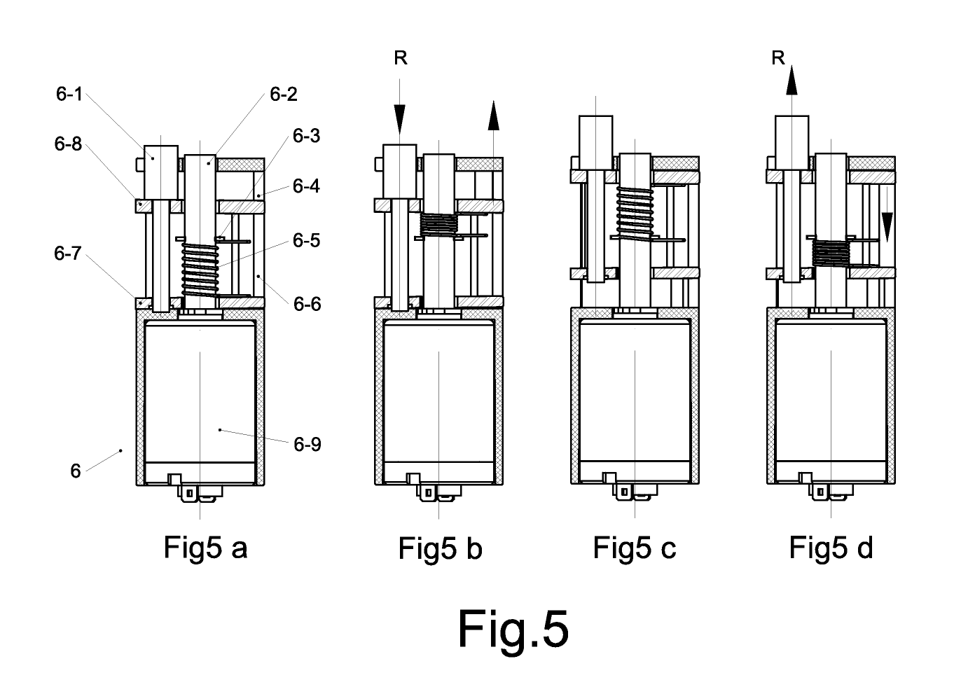

Refer to the FIGS. 5a to 5d; the device for locking block bar is a block pin device with spring accumulator, which includes an electric motor 6-9, a spring accumulator driven by the motor 6-9 and a block pin 6-1 driven by the accumulator, the block pin 6-1 shoots out to the space after the block bar 7 to lock the block bar 7 when no resistance force existed, the turn of motor 6-9 is not synchronized with the shooting of the block pin 6-1 as having the accumulator.

The motor has a shaft 6-2 with a driving pin 6-3, a helical spring 6-5 is on the shaft 6-2. A block pin 6-1 fixed with an upper baffle 6-8 and a bottom baffle 6-7 is beside the shaft 6-2, the helical spring 6-5 is between the upper and bottom baffles 6-8, 6-7. When the motor 6-9 turns, the driving pin 6-3 drives the helical spring 6-5 up or down, it depends the helical spring 6-5 being left or right hand and the turn direction of the motor 6-9. The helical spring 6-5 pushes the upper baffle 6-8 together with the block pin 6-1 moving up or down, then the block pin 6-1 shoots out to the space behind the block bar 7 or withdraws in. The helical spring 6-5 will be compressed if the block pin 6-1 is stopped by a resistance R.

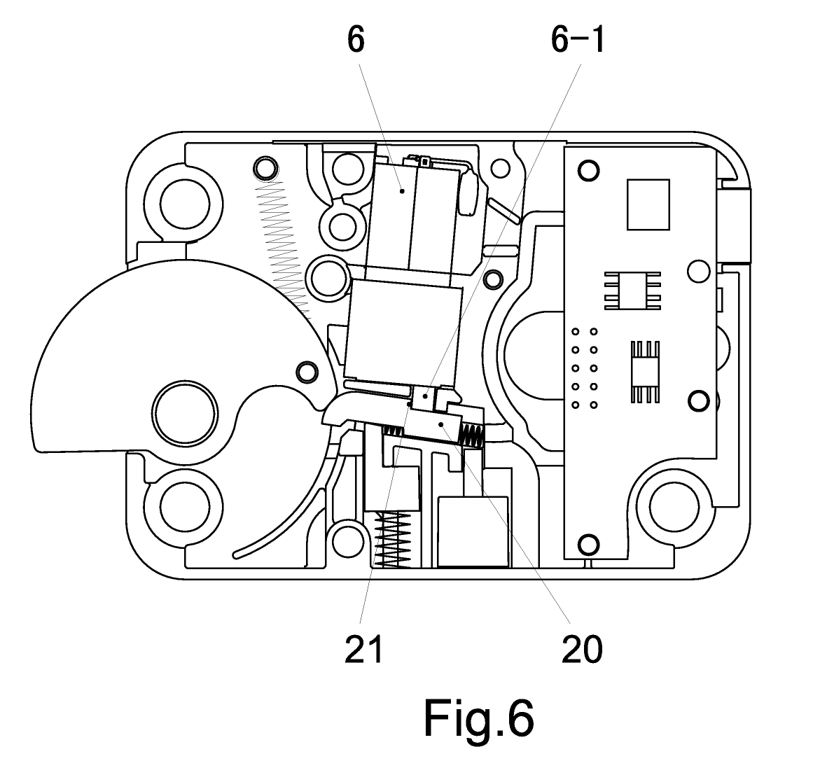

Refer to FIG. 6; the electric motor 6-9 is controlled by an electric controlling system 15. After passing the tests of pass word, fingerprint and key the controlling system 15 makes the motor 6-9 power on in inching, the motor 6-9 turns in a direction to withdraw the block pin 6-1, the door can be opened. After closing of the door, the controlling system 15 makes the motor 6-9 power on in inching but in reversed pole, then the motor turns in a reversed direction to shoot out the block pin 6-1 into the space behind the block bar 7, the door is locked.

Refer to FIG. 1; the door of the safety box is closed:

The block pin 6-1 shoots out in the space behind the block bar 7 to stop the block bar 7 moving right, thereby the keeper 2 cannot turn in clockwise, and the door is locked.

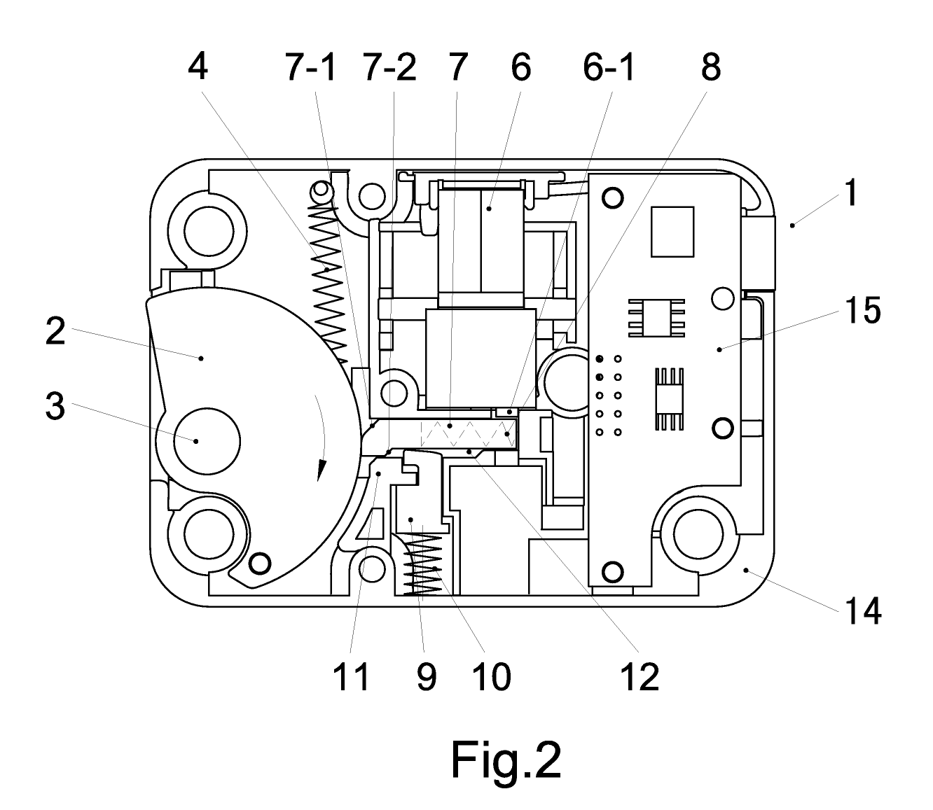

Refer to FIG. 2; the door of the safety box is opened:

The motor 6-9 is power on in inching, the block pin 6-1 withdraws to inside; pull the door, the pulling force pushes the latch portion 2-2 to turn the keeper 2 in clockwise; then the tail portion 2-1 of the keeper 2 pushes the arc shape head 7-1 of the block bar 7 to force it moving right as the block pin 6-1 has withdrawn, the door is opened.

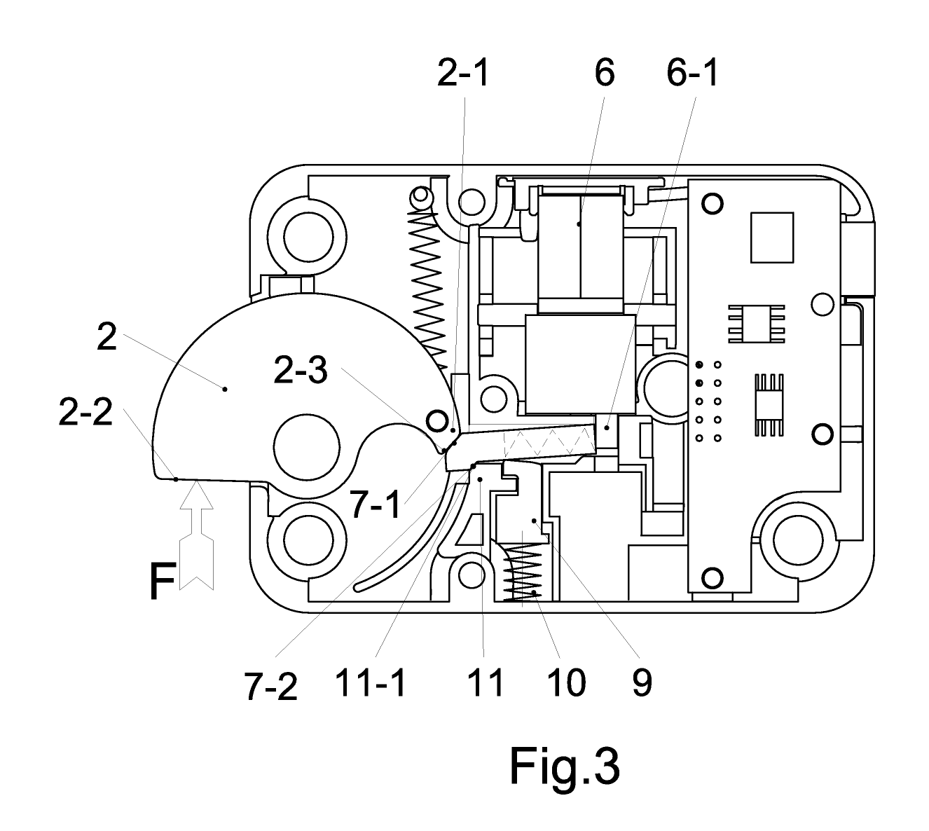

Refer to FIG. 3; the door of the safety box is in impact:

A impact F acts on the door, the impact F is transferred to the keeper 2 then to the arc shape head 7-1 of the block bar 7 through the bevel face 2-3 of the tail portion 2-1, the impact F forces the head of the block bar 7 to move down, then the inclined plan 7-2 of the block bar 7 impacts the inclined head 11-1 of the reinforced triangle rib 11 to transfer the impact F to the reinforced triangle rib 11. As having clearance between the groove 12 and block bar 7, any part will not be damaged by the impact F. The reinforced rib 11 is designed to against 1000 kg impact without becoming broken or distorted. Therefore the new lock can against 1000 kg impact. After impacting the support, column 9 pushes the block bar 7 back to its original place under the force of forth spring 10.

Refer to FIGS. 5a to 5d; the working principles of the block pin device with spring accumulator:

FIGS. 5a and 5b show that the motor 6-9 turns in counter clockwise after the door is closed. The driving pin 6-3 drives the helix spring 6-5 to move up, the helix spring 6-5 pushes the upper baffle 6-8 with the block pin 6-1 to move up, thereby the block pin 6-1 shoots out. When a resistance R stops the block pin 6-1 shooting out, the motor 6-9 runs continuously and the driving pin 6-3 comprises the helical spring 6-5 until the motor 6-9 stop. When the resistance R is disappeared, the compressed helical spring 6-5 pushes the upper baffle 6-8 with the block pin 6-1 moving up regardless the motor 6-9 is stopped, thereby the block pin 6-1 still can shoot out when the motor stop.

FIGS. 5c and 5d show that the motor turns in counter clockwise when the door is opened. The driving pin 6-3 drives the helix spring 6-5 to move down, the helix spring 6-5 pushes the bottom baffle 6-7 with the block pin 6-1 to move down, thereby the block pin 6-1 withdraws. When a resistance R stops the block pin 6-1 to withdraw, the motor 6-9 runs continuously and the driving pin 6-3 comprises the helical spring 6-5 until the motor 6-9 stop. When the resistance R disappeared, the compressed helical spring 6-5 pushes the bottom baffle 6-7 with the block pin 6-1 moving down regardless the motor is stopped, thereby the block pin 6-1 can still withdraw when the motor stop. The death problem of lock is solved.

FIG. 6 shows another preferred embodiment of the present invention. The top of the block bar 20 has a step 21, the block pin 6-1 shoots out behind the step 21; the block bar 20 is locked.

The block pin 6-1 withdraws, the block bar 20 can be pushed back. The other structures and operating processes are the same as the embodiment described above.

FIG. 7 shows the electrical controlling for the new lock of the present invention. An electronic circle plate 15 consists of an electrical controlling system for controlling the operation of the motor 6-9. When tests of password and fingerprint are passed, the controlling system 15 makes the motor power on in inching, and the motor 6-9 runs in a direction, when the door is closed, the controlling system 15 makes the motor power on in reversed pole and in inching, and the motor 6-9 runs in an opposite direction.

The advantages of the new electric anti-impact lock with spring accumulator of the present invention are obvious:

The new electric anti-impact lock with spring accumulator solves the problem of weakness, which exists in the current electromagnetic locks in market, the new lock can guarantee no any break or distortion under 1000 kg impact. The new lock solves the death problem of current electromagnetic locks in market. The manufacture of the new lock is easy and the cost of the new lock is lower than the current electromagnetic locks.

Although the description above contains much specificity, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. An electric anti-impact lock with spring accumulator comprising:
a lock shell;
a pivot keeper for locking door with a latch portion and a tail portion, the door can be opened when the latch portion pivoting into the shell, the door being locked when the latch portion pivoting outside the shell;
a device for locking keeper comprising a slideable block bar, the keeper being locked when the block bar being against the tail portion, the keeper being turnable when the block being moved away;
an anti-impact device having a reinforce structure, which bears an impact from the door through the keeper and block bar;
a device for locking block bar having a block pin device with spring accumulator, a block pin shooting out into the space behind the block bar to stop moving of the block bar when power on, thereby the door being locked, the block pin withdrawing to free the stop of the block bar when power on in reverse pole, thereby the door can be opened.

2. The lock of claim 1, wherein the keeper has a cam shape with a latch portion having beeline outline at one end and a tail portion having a bevel face at other end, the keeper is pivoted on a keeper pivot, one end of a first spring is connected with the tail portion and other end is connected with the shell.

3. The lock of claim 1, wherein the device for locking keeper includes a groove, the block bar is slideable in the groove, a second spring is a compress spring, one end of the second spring is against the block bar, other end is against the shell, the block bar is against the tail portion of the keeper by the force of second spring.

4. The lock of claim 3, wherein the block bar is a flat piece, has an arc shape head and an inclined plane opposite to the arc shape, an flute is on a side of the block bar, in which the second spring is located.

5. The lock of claim 4, wherein the anti-impact device includes the reinforce structure constructed as an reinforced triangle rib having a inclined head opposite to the inclined plane of the block bar, the impact acted on the door is transferred to the reinforced triangle rib through the inclined plane of the block bar and inclined head of the reinforced triangle rib.

6. The lock of claim 5, wherein the groove is wider than the block bar, a support column is against the block bar, a forth spring is against the support column, the block bar is pushed against one side of the groove by the force of the forth spring, an impact will push the block bar to press the support column down, then the inclined plane of the block bar touches and transfers the impact to the inclined head of the triangle reinforced rib.

7. The lock of claim 1, wherein the block pin device with spring accumulator includes an electric motor, a spring accumulator driven by the motor and a block pin driven by the accumulator, the block pin shooting out to the space after the block bar to lock the block bar, thereby the door is locked, the block pin withdraws from the space after the block bar to free the block bar, thereby the door can be opened, the block pin can be driven by the accumulator under the motor's stop.

8. The lock of claim 7, wherein the spring accumulator has a helical spring on the shaft of the motor, the shaft has a driving pin fixed with an upper baffle and a bottom baffle, the helical spring is between the upper and bottom baffles; when the motor turns in one direction, the driving pin drives the helical spring up or down, the helical spring pushes the upper baffle with the driving pin moving up or down, the helical spring will be compressed if a resistance stops the block pin, the compressed spring will push the block pin in or out if the resistance disappears and the motor is stopped.

9. The lock of claim 8, wherein the motor is turned in inching when the motor is in stop, the block pin can be shot out continuously until the compressed helical spring released.

10. The lock of claim 6, wherein the support column can be omitted, and the forth spring is against the block bar directly.

11. The lock of claim 4, wherein the top of the block bar has a step.

12. The lock of claim 12, wherein the a block pin shooting out behind the step of the block bar to stop moving of the block bar when power on, thereby the door being locked, the block pin withdrawing to free the stop of the block bar when power on in reverse pole, thereby the door can be opened.

13. The lock of claim 1, wherein an electrical controlling system controls the operation of the motor, when tests of password and fingerprint are passed, the controlling system makes the motor power on in inching, and the motor runs in a direction, when the door is closed, the controlling system makes the motor power on in reversed pole and in inching, and the motor runs in a opposite direction.
